(19) United States
(12) Patent Application Publication
(10) Pub. No.: US 2003/0009585 A1
(43) Pub. Date: Jan. 9, 2003

(54) Dynamic policy based routing

(76) Inventors: Brian Antoine, Otis Orchards, WA (US); Guy C. Erb, Spokane, WA (US); Bruce Oscarson, Spokane, WA (US); Carl Allen Paukstis, Spokane, WA (US); David Schmidt, Spokane, WA (US)

Correspondence Address: CHRISTIE, PARKER & HALE, LLP, 350 WEST COLORADO BOULEVARD, SUITE 500, PASADENA, CA, 91105, US

(21) Appl. No.: 10/023,542

(22) Filed: Dec. 17, 2001

Related U.S. Application Data
(60) Provisional application No. 60/303,710, filed on Jul. 6, 2001.

(51) Int. Cl. G06F 15/173; H04L 12/28; H04L 12/56

(52) U.S. Cl. 709/238; 370/401

(57) ABSTRACT

A router is configured to provide dynamic policy based in accordance with a plurality of traffic parameters in the packet. The router includes a processor that determines a destination for a packet in accordance with the result of a comparison of a plurality of traffic parameters in the packet with a predetermined traffic profile. The router processor may then forward the packet on a selected one of a plurality of possible routes, in accordance with a dynamic routing protocol.

### FIELD OF THE INVENTION

The present invention is generally related to internetworking routing and is more particularly related to policy based routing systems.

### BACKGROUND

As the computer revolution advances, computer networking has become increasingly important. In recent years the number of computers which are connected to computer networks has increased rapidly. Not only are computers being connected to local networks, which might exist in a given building or group of buildings, but also wide area networks, which commonly connect local area networks in widely separated locations, such as the different facilities of a large corporation. In fact, within the last several years it has become increasingly common for computers to be hooked up to a global network formed of a large number of sub-networks called the Internet.

In today's high performance internetworks, organizations need the freedom to implement packet forwarding and routing in accordance with their own uniquely defined policies. This is impractical for existing destination based routing protocols that forward packets in accordance with a best route determined by a dynamic routing protocol such as for example open shortest path first (OSPF) or routing information protocol (RIP). Destination based routing does not allow network administrators to assign different routes for different users on a metropolitan area network (MAN), for instance, to respect the preferences of enterprise users for particular Internet service providers (ISP).

More recently policy-based routing (PBR) protocols have been developed that provide a mechanism for forwarding/routing of data packets based on the policies defined by the network administrators. It provides a more flexible mechanism for routing packets through routers, complementing the existing mechanism provided by routing protocols. However, instead of routing by the destination address, policy-based routing allows network administrators to determine and implement routing policies to allow or deny paths based on for example, the source address of the packet, packet size, application etc. The policy-based route may traverse, for instance, a particular ISP, thereby providing user defined connectivity (beyond the high-speed MAN) into the Internet.

However, typical policy based routing may be more prone to human errors resulting in routing loops and misrouted traffic. Moreover, because the policy-based routes are static, the policy-based routes are unable to recover from network state changes, such as link failures along the policy-based routes. Therefore, it would be advantageous to provide a policy based routing method and system that dynamically routes packets in accordance with a plurality of traffic parameters in the packet including the source and destination addresses.

### SUMMARY OF THE INVENTION

In one aspect of the present invention a router includes a processor for routing a packet on a selected one of a plurality of possible routes, characterized in that the plurality of routes include a policy-based route determined in accordance with a dynamic routing protocol.

In another aspect of the present invention, a router includes a processor for routing a packet on a selected one of a plurality of possible routes, wherein the plurality of routes are determined in accordance with a dynamic routing protocol and wherein the route selection is made in accordance with the result of a comparison of a plurality of traffic parameters in the packet with a predetermined traffic profile.

In further aspect of the present invention a method for routing signals in a communication network includes the steps of comparing the destination address of a received signal to one or more known destination addresses, determining a destination for the received signal in accordance with a source identifier in the received signal when the destination address of the received signal does not match any one of the known destination addresses, and determining a route for the received signal in accordance with a dynamic routing protocol.

### BRIEF DESCRIPTION OF THE DRAWING

These and other features, aspects, and advantages of the present invention will become better understood with regard to the following description, appended claims, and accompanying drawings where:

FIG. 1 is a simplified block diagram of an inter-network system having a routing switch that operates in accordance with an exemplary embodiment of the present invention; and

FIG. 2 is a flow chart that graphically illustrates operation of a method for routing packets in accordance with an exemplary embodiment of the present invention.

### DESCRIPTION OF THE INVENTION

An exemplary embodiment of the present invention provides a method and apparatus for routing packets on a selected route in accordance with a policy-based route determined in accordance with a dynamic routing protocol. In order to appreciate the advantages of the present invention, it will be beneficial to describe the invention in the context of an exemplary inter-network system.

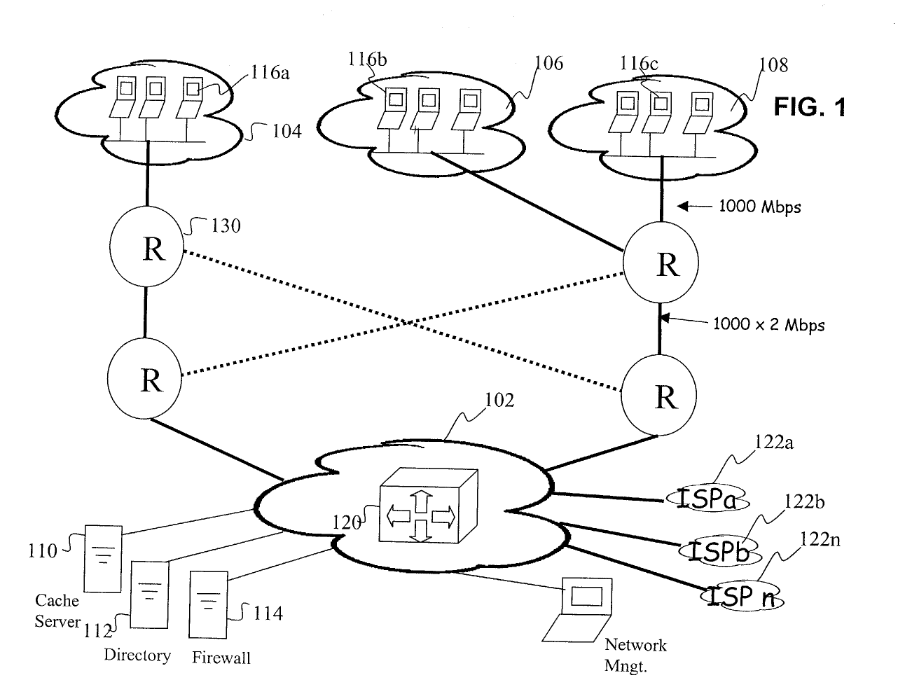

Internetworking is the process of establishing and maintaining communications between and transferring data among a plurality of local networks in a distributed network system. FIG. 1 depicts an exemplary embodiment of a metropolitan area network, comprising a plurality of local area networks 104, 106 and 108 coupled to a backbone network 102. The metropolitan area network is a hierarchical system wherein the backbone 102 is the top-level, or central, connection path shared by the nodes and networks connected to it. The backbone manages the bulk of the traffic between communicating nodes to provide end-to-end service between one user (i.e., a source node) and another user (i.e., a destination node). In addition the backbone may also provide bi-directional communication between end users and a plurality of local services such as, for example, a cache server 110, a directory server 112 or firewall 114 that may be coupled to the backbone.

Each local area network couples one or more end systems and resources 116a, 116b and 116c, such as workstations, servers, printers, and the like, to the backbone through one or more routers (generally identified at 130). As is known in the art, for purposes of redundancy and load sharing more than one router may be used to connect the local area networks to the backbone. One of skill in the art will appreciate that the present invention is not limited to applications involving a particular combination of local area networks. Rather, the present invention is equally applicable to any combination of local area networks. In addition, the LANs in this and other embodiments may have one or more different configurations including, but not limited to, Ethernet (IEEE 802.3), token ring (IEEE 802.5) and FDDI (ANSI X3T9.5). Therefore, the described exemplary embodiment is by way of example only and not by way of limitation.

A router's major function is to route messages that are sent to it. The described exemplary routing protocol preferably uses two addressing schemes, the hardware dependent physical addresses of the individual local networks directly coupled to it, and the hardware independent network-level addresses that represent addresses in the logical network. The routers within the inter-network manage communications among local networks and communicate with each other using an Interior Gateway Protocol, or IGP. In routing packets in the inter-network, a router may select from more than one path to a selected destination. When there is more than one path, there is a possibility that the router can distribute packet traffic among the paths, so as to reduce the aggregate packet traffic load on any one individual path. This concept is known in the art of network routing as load sharing.

In the described exemplary embodiment a routing switch 120 in the backbone 102 may be coupled to a plurality of Internet service providers 122a, 122b, . . . 122n(ISPs) each having a gateway that is connected to, and thus part of a logical network such as, for example, the Internet. The ISPs preferably support a network level addressing scheme, such as, for example, exterior gateway protocol (EGP). End systems 116 may send and receive messages to and from any other end system connected to the Internet via their respective ISP.

In accordance with an exemplary embodiment, routing switch 120 reads the network-level destination address of a message sent to it and forwards that message in accordance with the network-level address. In the described exemplary embodiment, the routing switch 120 determines if the network-level destination address corresponds to a system on one of the individual physical networks connected to the routing switch 120. If so, the routing switch sends the message out on that physical network, containing not only the end system's network-level destination address, but also preferably its physical-level address, so the hardware on the addressed system will know the message is for it.

If the routing switch 120 receives a message having a network-level destination address that does not correspond to any system on one of the physical networks connected to the routing switch, the routing switch sends the message out to an ISP gateway by way of one or more routers. Communications among these routers typically comprise an exchange (i.e., advertise) of routing information. This exchange occurs between routers at the same routing level (referred to as peer routers) as well as between routers at different routing levels. Conventionally, packets may then be forwarded in accordance with a best route determined by a dynamic routing protocol in accordance with the link state advertisements received during peer sessions.

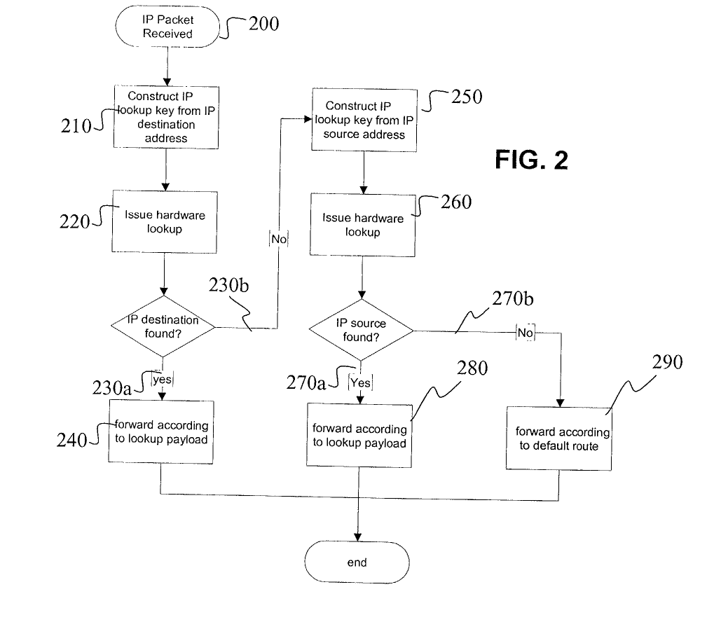

In accordance with an exemplary embodiment of the present invention, the routing switch 120 utilizes Internet Protocol source address (IPSA) aware routing to forward communications from end systems 116 toward one of the ISPs 122a, . . . 122n, another end system in a different local area network, or to one of the local services coupled to the backbone 102. Referring to FIG. 2, IPSA aware routing preferably uses a multi-stage lookup to allow both IP destination routing as well as IP source routing. Therefore, in the described exemplary embodiment, packets intended for one of the local services coupled to the backbone such as, for example, the cache server are routed towards the local cache server based on the IP destination address.

In operation next hop determinations may be based upon at least a portion of the destination address which is typically exchanged amongst peer routers. Therefore, the described exemplary router preferably stores destination addresses in a forwarding information database. When a router receives an incoming message from a given one of its physical interfaces 200, it sends the message up through the interface's associated network interface physical layer. This layer strips off the message's physical layer header and trailer, if any, and sends the message up to the IP layer.

In accordance with an exemplary embodiment the routing switch preferably stores a forwarding database constructed in accordance with the destination address. To determine the next hop the router processor may then construct a look-up key in accordance with the IP source address of the packet 210. The router processor may then utilize an address matching algorithm to search the forwarding database for an entry corresponding to the destination address located in the network layer header 220. If the destination address is found 230(a) the router processor sends the message back down to the network interface physical layer associated with the physical network over which the message is to be transmitted. The network interface physical layer then adds a new physical layer header indicating the physical address of the next hop in the message's routing. Then the message is transmitted out over the selected physical interface 240.

In accordance with an exemplary embodiment, if the IP destination address of the packet is unknown 230(b), IPSA aware routing forwards that packet in accordance with the IP source address of the packet. In operation, a source address database may be used to correlate masked IP source addresses with a related ISP gateway. In this instance, the router processor may then construct a look-up key in accordance with the IP source address of the packet 250. The router processor may then utilize an address matching algorithm that searches the source address database for an entry corresponding to the source address located in the network layer header 260. If the source address is found 270(a), the described exemplary routing protocol forwards the message to the ISP gateway associated with the IP source address in the payload of the source address database 280.

In the described exemplary embodiment, a packet may be forwarded along a default route 290 when the IP source address of the packet indicates that the packet should be routed via one of the available exterior paths (e.g. ISPs) and the IP source address does not correlate to certain exterior paths 270(b). In accordance with an exemplary embodiment, the default route may be configured manually in accordance with a variety of criteria. For example, the router's operator may define a default route that provides the lowest traffic rates or may decide to simply drop packets that have an unmatched source address.

In accordance with an exemplary embodiment, the backbone routing switch 120 does not participate in the exterior gateway protocol (EGP) supported by the ISPs. Exterior Gateway Protocols such as for example, Border Gateway Protocol (BGP) or Open Shortest Path First (OSPF) are protocols for exchanging routing information between two neighbor gateway hosts (each with its own router) in a network of autonomous systems. An EGP is commonly used between hosts on the Internet to exchange routing table information. The routing table contains a list of known routers, the addresses they can reach, and a cost metric associated with the path to each router so that the best available route is chosen. Each router polls its neighbor at intervals between 120 to 480 seconds and the neighbor responds by sending its complete routing table.

Rather the ISP gateway addresses and best routes are leaked into the interior gateway protocol (IGP) of the metropolitan area network. An IGP is a protocol for exchanging routing information between gateways (hosts with routers) within an autonomous network (for example, a system of corporate local area networks). The routing information can then be used by the Internet Protocol (IP) or other network protocols to specify how to route transmissions.

In one embodiment the IPSA aware routing code within the routing switch monitors the forwarding database being managed by the IGP. In accordance with an exemplary embodiment, if the IGP routing database gets a new or updated entry describing the reachability or best route of an ISP, the IPSA aware protocol preferably updates the source address database to reflect the new best route.

Alternatively, in accordance with an exemplary embodiment the router processor may determine a destination address for an incoming packet in accordance with the IP source address of the packet stored in the IPSA forwarding database. In this embodiment, the router processor may then determine the best route to the destination IP address associated with an IPSA in accordance with the routing table maintained by the interior gateway protocol.

Thus in operation, the router processor may utilize an address matching algorithm to search the standard IP routing table maintained by the interior gateway protocol (IGP) to determine the best route for the IP destination address stored in the IPSA forwarding database. Successful routing of incoming packets requires that a logical path (a collection of one or more links) exist in the network between the source and destination for that packet. Based on the contents of its routing table, the routing switch ascertains the identity of the downstream router (or data destination) to receive the packet. Assuming the network possesses sufficient physical redundancy (e.g., multiple routers, multiple links), the network can dynamically redefine paths using protocols such as the Border Gateway Protocol (BGP) or Open Shortest Path First (OSPF) protocol, in case of a router or link failure. The use of such protocols ensures that no one router or link failure disrupts the flow of packets between a data source and destination.

Advantageously, the described exemplary routing protocol and forwarding rules are self maintaining, and automatically react to topology changes, as indicated by the dynamic routing protocols. In operation, packets are therefore forwarded to an ISP gateway in accordance with route information that is largely resilient to topology changes. The exemplary routing protocol therefore reduces the creation of routing loops and other routing discrepancies as compared to conventional policy based routing protocols that forward packets in accordance with static forwarding rules. Further, in one embodiment, the destination forwarding database and the source forwarding database may be implemented in hardware so that the described exemplary protocol may be implemented at wire speed with no loss in data throughput.

The advantages of the present invention may be best understood in the context of an illustrative example demonstrating the rerouting of a packet. Referring back to the simplified block diagram of FIG. 1, routing switch 120 provides standard hardware routing support, that is it has a hardware routing table that may be maintained by one of a variety of routing protocols known in the art. These tables represent the ‘best’ route to a specific IP destination address based on the routing protocols in use.

In the described exemplary embodiment a IPSA forwarding database stores the IPSA routing policy in a hardware lookup table on the routing switch. In an exemplary embodiment, a network administrator, rather than a routing protocol, manages the IPSA table since the IPSA table represents policy based routing information. The IPSA table preferably associates one or more IP source addresses with a specific IP destination address. In general the IPSA table may associate source network address with a subnet mask and an ISP's destination gateway address as shown below

Ipsa route <source network address> <subnet mask> <destination gateway address>

For example, for purposes of illustration suppose ISP(a) has a destination gateway address of 129.189.1.1, then from the command line interface the following association might stored in the IPSA forwarding database.

PR-5200> ipsa route 129.189.2.0 255.255.255.0 129.189.1.1

This table entry indicates that some packets received from IP source addresses 129.189.2.0/24 should be forwarded towards the gateway 129.189.1.1. In a metropolitan area network (MAN) it may not be desirable to always forward traffic towards an associated ISP. For example, local high speed services offered in the MAN should not be IPSA aware routed.

Therefore, in the described exemplary embodiment, anything advertised via the interior gateway protocol (IGP) is not IPSA aware routed. Therefore, when routing an incoming packet, the routing switch first performs a source matching hardware lookup in the standard IP routing table to determine if the destination address has a defined route. If the destination address is found the routing switch forwards the packet in accordance with the best route information stored in the standard IP routing table.

Furthermore, an IP destination address match with the default route is preferably not considered a direct match. In this case the routing switch only uses the default route when there is not a IPSA match in the IPSA forwarding database. Therefore, in operation, the described exemplary routing switch only forwards incoming packets in accordance with the default route when all other attempts at determining the forwarding route fail.

If a route is not defined for the destination address the routing switch may then utilize an address matching algorithm that searches the IPSA forwarding database for an entry corresponding to the source. In accordance with an exemplary embodiment the routing switch treats the destination IP address associated with this IPSA entry as if it had been the actual IP destination address in the packet.

Thus in operation, the routing switch may utilize an address matching algorithm to search the standard IP routing table maintained by the interior gateway protocol (IGP) to determine the best route for the IP destination address stored in the IPSA forwarding database. The routing switch may then route the packet in accordance with this best route and copy the corresponding forwarding information for the gateway into the IPSA forwarding database. In the described exemplary embodiment, the IP destination address of the packet header is not changed.

In practice most ISPs only allocate one address to a single customer. In the majority of cases this address is assigned dynamically, so that every time a client connects to the ISP a different address may be provided. Big companies can buy more addresses, but for small businesses and home users the cost of doing so is prohibitive. Because such users are given only one IP address, they can have only one computer connected to the Internet at one time. However, with a network address translation (NAT) gateway, it is possible to share that single address between multiple local computers and connect them all at the same time. The outside world is unaware of this division and thinks that only one computer is connected. Therefore, the described exemplary dynamic routing system may be utilized in conjunction with locally defined addresses. For example, the IPSA forwarding database may include entries that associate a locally defined computer on a particular subnet as follows:

PR-5200> IPSA route 10.0.2.0 255.255.255.0 129.189.1.1

In this example, incoming packets from a locally defined 10.0.2.0/24 address are routed towards a particular ISP destination addresses namely, 129.189.1.1. In practice there are few limits on the number of IP destination addresses that may be defined or the number of source subnets that can be assigned to an IP destination address.

The described exemplary embodiment provides a method for dynamically routing data packets in accordance with policies defined by the network administrators. Dynamic policy based routing provides a more flexible mechanism that conventional policy based systems wherein a network administrator configures static routes from an IPSA-aware router to various ISPs. The described exemplary embodiment avoids link failures due to network state changes that may occur in conventional policy based systems.

Although a preferred embodiment of the present invention has been described, it should not be construed to limit the scope of the appended claims. Those skilled in the art will understand that various modifications may be made to the described embodiment and that numerous other configurations are capable of achieving this same result. For example, a user may encode alternate source identifiers into a data packet. The alternate source identifier may then be used to determine a destination as previously described.

Moreover, to those skilled in the various arts, the invention itself herein will suggest solutions to other tasks and adaptations for other applications. It is the applicants intention to cover by claims all such uses of the invention and those changes and modifications which could be made to the embodiments of the invention herein chosen for the purpose of disclosure without departing from the spirit and scope of the invention.

What is claimed is:

1. A router, comprising a processor for routing a packet on a selected one of a plurality of routes, wherein the plurality of routes include a policy-based route determined in accordance with a dynamic routing protocol.

2. The router according to claim 1 wherein the plurality of routes further comprises a destination-based route determined in accordance with a dynamic routing protocol.

3. The router according to claim 1 wherein the policy-based route is modified in accordance with the dynamic routing protocol upon detecting a network state change.

4. A router including a processor for routing a packet on a selected one of a plurality of routes, characterized in that the plurality of routes are determined in accordance with a dynamic routing protocol and in that the route selection is made in accordance with the result of a comparison of a plurality of traffic parameters in the packet with a predetermined traffic profile.

5. The router according to claim 4 wherein the plurality of traffic parameters comprises a source address and a destination address.

6. The router according to claim 5 further comprising a source address look-up table having stored source address and an address of a related Internet service provider and wherein the route selection is made in accordance with the result of a comparison of source address in the packet with stored source address in the source address look-up table.

7. The router according to claim 6 wherein the source address look-up table comprises a hardware look-up table.

8. The router according to claim 5 further comprising a destination address look-up table having stored destination addresses and wherein the route selection is made in accordance with the result of a comparison of destination address in the packet with the stored destination address in the destination address look-up table.

9. The router according to claim 6 wherein the destination address look-up table comprises a hardware look-up table.

10. A method of routing signals in a communication network, comprising the steps of:
determining a destination in accordance with a source identifier in a received signal; and
forwarding said signal to said destination in accordance with a dynamic routing protocol.

11. The method of claim 10 wherein the step of determining a destination in accordance with a source identifier in a received signal comprises determining a destination in accordance with source address of said received signal.

12. The method of claim 10 further comprising storing an ISP for one or more source identifiers, and wherein the destination may be determined in accordance with said stored ISPs.

13. The method of claim 10 wherein the step of forwarding the received signal to said destination in accordance with a dynamic routing protocol comprises forwarding said received signal in accordance with an exterior gateway protocol.

14. A method of routing signals in a communication network, comprising the steps of:
comparing destination address of a received signal to one or more known destination addresses;
determining a destination for said received signal in accordance with a source identifier in said received signal when the destination address of said received signal does not match any one of said known destination addresses; and
determining route for said received signal in accordance with a dynamic routing protocol.

15. The method of claim 14 further comprising the step of storing known destination addresses in a destination address look-up table.

16. The method of claim 15 wherein the step of storing known destination addresses in a destination address look-up table comprises storing known destination addresses in a hardware look-up table.

17. The method of claim 14 further comprising the step of storing an ISP for one or more source identifiers in a source address look-up table, and wherein the destination may be determined in accordance with said stored ISPs.

18. The method of claim 17 wherein the step of storing ISPs in a source address look-up table comprises storing ISPs in a hardware look-up table.

19. The method of claim 14 wherein the step of determining route for said received signal in accordance with a dynamic routing protocol comprises determining route for received signal in accordance with an exterior gateway protocol.

20. The method of claim 14 wherein the step of determining a destination for said received signal in accordance with a source identifier in said received signal comprises determining a destination for said received signal in accordance with source address of said received signal.
